(19) United States
(12) Patent Application Publication
(10) Pub. No.: US 2013/0135422 A1
(43) Pub. Date: May 30, 2013

(54) IMAGE PROCESSING APPARATUS, METHOD, AND PROGRAM

(71) Applicant: Ryo KOBAYASHI, Kanagawa (JP)

(72) Inventor: Ryo KOBAYASHI, Kanagawa (JP)

(21) Appl. No.: 13/681,800

(22) Filed: Nov. 20, 2012

(30) Foreign Application Priority Data
Nov. 28, 2011 (JP) 2011-259526

(51) Int. Cl. B41J 2/435

(52) U.S. Cl. CPC G03G 15/5004; G03G 13/04
USPC 347/224

(57) ABSTRACT

An image processing apparatus includes an exposure unit to expose a photoconductor to form an electrostatic latent image on the photoconductor; a development unit to develop the electrostatic latent image on the photoconductor as a toner image using toner; and an exposure power controller to control exposure power of the exposure unit depending on a printing mode, including a normal printing mode and a toner-save printing mode in which less toner is consumed than in the normal printing mode. The exposure power controller decreases the exposure power of the exposure unit for the toner-save printing mode compared to the exposure power of the exposure unit for the normal printing mode.

### CROSS-REFERENCE TO RELATED APPLICATION

This application claims priority to Japanese Patent Application No. 2011-259526, filed on Nov. 28, 2011 in the Japan Patent Office, the disclosure of which is incorporated by reference herein in its entirety.

### BACKGROUND

1. Technical Field

The present invention relates to an image processing apparatus, an image processing method, and an image processing program.

2. Description of the Background Art

There is continuing market demand for image processing apparatuses capable of printing at reduced cost. Accordingly, image processing apparatuses such as laser printers include an exposure unit to expose a photoconductor to form an electrostatic latent image on the photoconductor and a development unit to develop the electrostatic latent image using toner to form a toner image. Additionally, these image processing apparatuses may be provided with a normal printing mode and a toner-save printing mode for printing toner images with less toner than in the normal printing mode.

Thus, for example, JP-2003-295701-A discloses a method to reduce the amount of toner consumed for the toner-save printing mode compared to the amount of toner consumed for the normal printing mode by using a CMYK gamma table. Specifically, output values set for the normal printing mode are adjusted to lower values for the toner-save printing mode to reduce the amount of toner consumed. Typically, dithering is applied to solid image areas to reduce the amount of toner consumed.

Further, JP-4053214-B (JP-2001-194855-A) discloses a method of adjusting the development bias set for the normal printing mode to lower values for the toner-save printing mode to reduce the amount of toner consumed in the toner-save printing mode.

However, changing the gamma table for the toner-save printing mode may cause solid thin lines to disappear due to interference with the dithering pattern, thereby making edge portions of letters even more jagged.

If the value of the development bias for the toner-save printing mode is decreased as in JP-2003-295701-A, the above-mentioned disappearance of solid thin lines due to interference with the dithering pattern and jaggedness at edge portions of letters can be suppressed. However, because the development bias adjustment cannot suppress the edge effect, toner particles are more likely to adhere to the edge portions of an image compared to the non-edge portions. Consequently, too many toner particles adhere to the edge portion of the image, and thereby the amount of toner consumed cannot be reduced effectively.

### SUMMARY

The present invention is conceived in light of the above-described problems, and provides a novel image processing apparatus. The image processing apparatus includes an exposure unit to expose a photoconductor to form an electrostatic latent image on the photoconductor; a development unit to develop the electrostatic latent image on the photoconductor as a toner image using toner; and an exposure power controller to control exposure power of the exposure unit depending on a printing mode including a normal printing mode and a toner-save printing mode in which less toner is consumed than in the normal printing mode. The exposure power controller decreases the exposure power of the exposure unit for the toner-save printing mode compared to the exposure power of the exposure unit for the normal printing mode.

The present invention further provides a novel an image processing method. The method includes the steps of: 1) exposing a photoconductor to form an electrostatic latent image on the photoconductor; 2) developing the electrostatic latent image on the photoconductor as a toner image using toner; 3) determining whether a toner-save printing mode is set; and 4) decreasing exposure power for the toner-save printing mode from the exposure power for the normal printing mode at the exposing step when the determining step determines that the toner-save printing mode is set.

The present invention further provides a novel A non-transitory computer-readable storage medium storing a program that, when executed by a computer, causes the computer to execute a method of image processing. The method includes the steps of: 1) exposing a photoconductor to form an electrostatic latent image on the photoconductor; 2) developing the electrostatic latent image on the photoconductor as a toner image using toner; 3) determining whether a toner-save printing mode is set; and 4) decreasing exposure power for the toner-save printing mode from the exposure power for the normal printing mode at the exposing step when the determining step determines that the toner-save printing mode is set.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 shows a printing system employing an image processing apparatus according to an example embodiment;

FIG. 2 shows a flow chart of steps of a printing process executed by the image processing apparatus of FIG. 1;

FIG. 3 schematically shows development field intensity and toner adhering amount on a photoconductor when exposure power is set at a higher value;

FIG. 4 schematically shows development field intensity and toner adhering amount on a photoconductor when exposure power is set at a lower value;

FIGS. 5(1) to 5(12) schematically show a conventional generation process of clustered dithering that processes small-dot in advance;

FIGS. 6(1) to 6(12) schematically show a conventional generation process of diffusion dithering that processes small-dot in advance;

FIGS. 7(1) to 7(11) schematically show a generation process of clustered dithering excluding a dithering pattern for discrete small-size dot when exposure power is changed; and

FIGS. 8(1) to 8(8) schematically show a generation process of diffusion dithering excluding a dithering pattern for discrete small-size dot when exposure power is changed.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result.

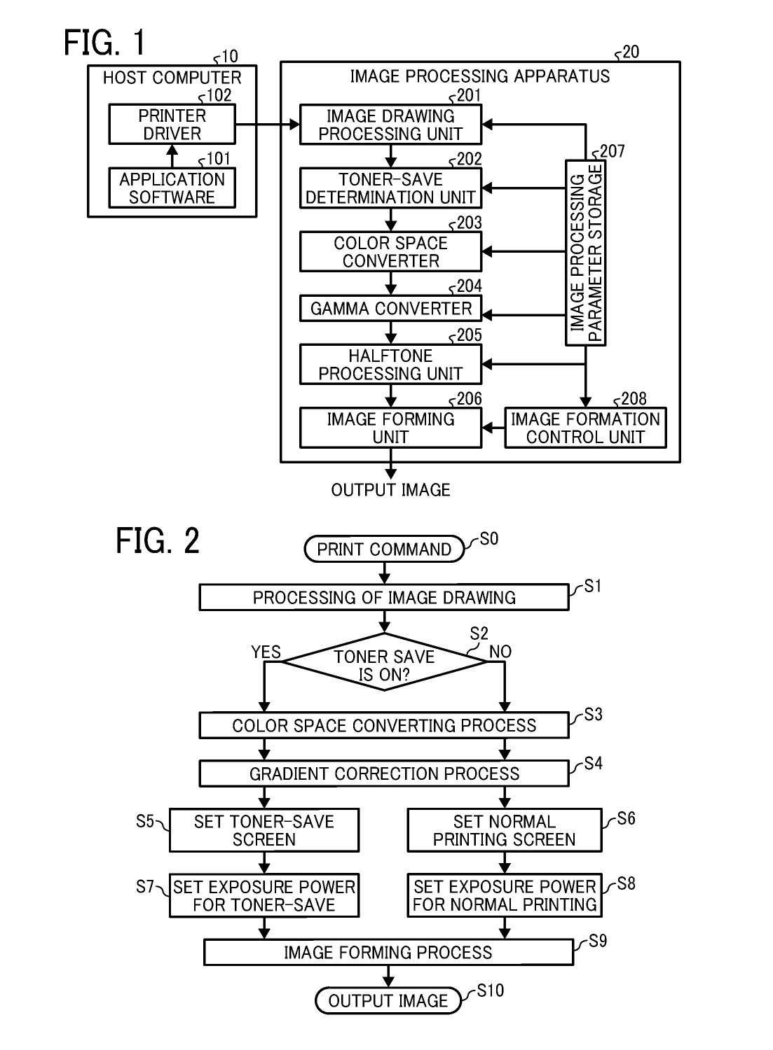

A description is now given of an image processing apparatus according to an example embodiment with reference to the drawings. FIG. 1 shows a printing system employing an image processing apparatus according to an example embodiment.

The printing system includes, for example, a host computer 10, and an image processing apparatus 20. The host computer 10 includes, for example, application software 101, and a printer driver 102. The image processing apparatus 20 includes, for example, an image drawing processing unit 201, a toner-save determination unit 202, a color space converter 203, a gamma converter 204, a halftone processing unit 205, an image forming unit 206, an image processing parameter storage 207, and an image formation control unit 208.

The host computer 10 transmits print data prepared by using the application software 101 to the image processing apparatus 20 via the printer driver 102. The image processing apparatus 20 forms images based on the received print data.

In such process, the printer driver 102 can set ON/OFF of the toner-save printing mode for the image processing apparatus 20, and a level of toner-saving consumption amount such as large-amount saving and small-amount saving when the toner-save printing mode is set ON. Then, the printer driver 102 reports the print data, parameters corresponding to the ON/OFF of the toner-save printing mode and the level of toner-saving consumption amount to the image processing apparatus 20.

Based on the print data received from other device such as the host computer 10, the image drawing processing unit 201 of the image processing apparatus 20 generates bitmap image data such as RGB-format image data. Based on the parameters received from the other device with the print data, the toner-save determination unit 202 determines the ON/OFF of the toner-save printing mode and the level of toner-saving consumption amount, and stores a determination result in the image processing parameter storage 207.

The color space converter 203 conducts a given color space converting process on the RGB-format image data generated by the image drawing processing unit 201 to convert RGB-format image data to CMYK-format image data process-able in the image forming unit 206 such as color printers.

The gamma converter 204 conducts a shading correction to the CMYK-format image data received from the color space converter 203. The halftone processing unit 205 generates image data of digital half-toning or pseudo continuous toning by conducting a screening process.

The image forming unit 206 includes, for example, a photoconductor, a charger, an exposure unit, a development unit, a transfer unit, and a fusing unit. The charger charges a surface of the photoconductor. The exposure unit has a light source such as a semiconductor laser and a light emitting diode (LED) array. The light source emits a light beam based on image data, and the light beam is radiated onto the surface of the photoconductor to expose the surface of the photoconductor to form an electrostatic latent image on the photoconductor. The development unit develops the electrostatic latent image formed on the surface of the photoconductor as a toner image using toner. The transfer unit transfers the toner images onto a recording medium such as a recording sheet. The fusing unit fuses the toner images on the recording medium. The image formation control unit 208 controls exposure conditions such as charge potential and exposure power, development condition, fusing condition of the image forming unit 206 to form images by the image forming unit 206. As such, the image formation control unit 208 can function as a controller to control the exposure power, which may be called as an exposure power controller.

The image processing parameter storage 207 stores parameters such as ON/OFF setting of toner-save printing mode, and the level of toner-saving consumption amount. Based on parameters stored in the image processing parameter storage 207, the image drawing processing unit 201, the toner-save determination unit 202, the color space converter 203, the gamma converter 204, the halftone processing unit 205, the image forming unit 206, and the image formation control unit 208 can be set with parameters for conducting the toner-save printing mode.

For example, if the exposure power of the exposure unit such as laser emission power in the image forming unit 206 is decreased to reduce the amount of toner consumed for the toner-save printing mode, the parameter of ON/OFF of the toner-save printing mode is set ON, stored in the image processing parameter storage 207, based on a determination result of the toner-save determination unit 202, and the parameter corresponding to the level of toner-saving consumption amount is also set. Specifically, the toner-save printing mode supports a selectable level of toner-saving consumption amount, and the image formation control unit 208 can function as the exposure power controller to variably set the exposure power of the exposure unit depending on a selected level of the toner-saving consumption amount.

Upon receiving information that the toner-save printing mode is set ON, the halftone processing unit 205 switches or shifts a screen for the normal printing mode to a screen for the toner-save printing mode. Based on information that the toner-save printing mode is set ON, the image formation control unit 208 adjusts the exposure power of the image forming unit 206 to a lower level compared to the normal printing mode, in which the exposure power is set based on the parameter of the level of toner-saving consumption amount corresponding to ON of the toner-save printing mode.

### (Printing Process)

FIG. 2 shows a flow chart of steps of a printing process of the image processing apparatus 20. When a print command or instruction including print data and the above described parameters is transmitted from the host computer 10 to the image processing apparatus 20 (step S0), the image drawing processing unit 201 conducts processing of image drawing (step S1).

Then, based on the parameters such as ON/OFF of the toner-save printing mode and the level of toner-saving consumption amount transmitted from the host computer 10 with the print data, the toner-save determination unit 202 determines whether toner saving is to be executed (step S2). The determination result is transmitted to the image processing parameter storage 207, and parameters corresponding to execution of the toner saving are set to concerned units by transmitting the parameters from the image processing parameter storage 207.

Upon determining the ON/OFF setting of the toner-save printing mode, the color space converter 203 conducts the color space converting process (step S3), and the gamma converter 204 conducts the gradient correction process (step S4). The color space converting and gradient correction processes can be conducted in the same way with or without setting the toner-save printing mode ON.

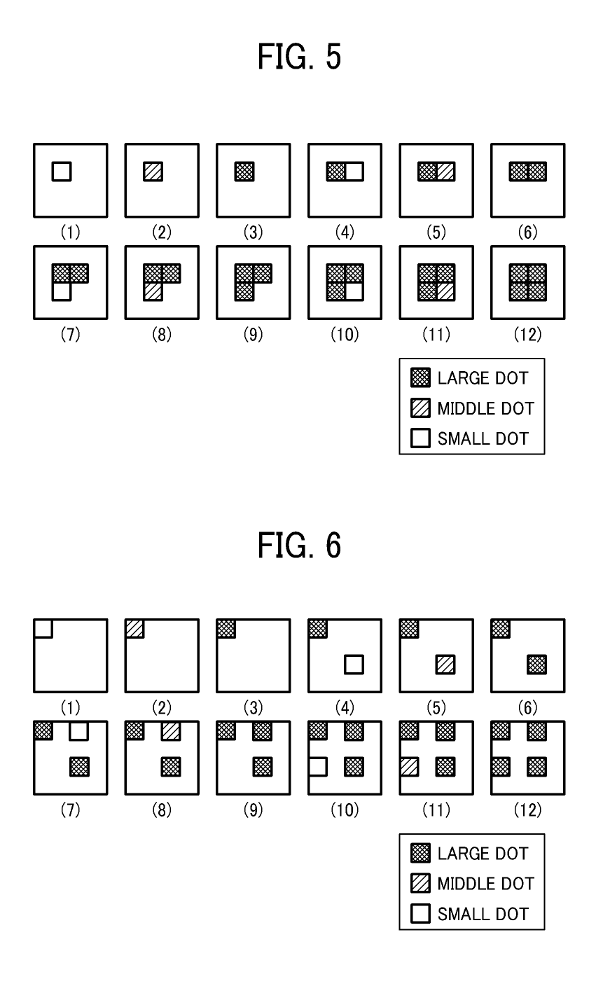

A screen is set for the halftone processing unit 205 differently depending on ON/OFF of the toner-save printing mode. Specifically, when the toner-save printing mode is set ON (step S2: YES), a screen for the toner-save printing mode is set (step S5), and when the toner-save printing mode is set OFF (step S2: NO), a screen for the normal printing mode is set (step S6). The effect of the screen for the toner-save printing mode will be described later with reference to FIGS. 5 to 8.

The exposure power is set for the image formation control unit 208 differently depending on ON/OFF of the toner-save printing mode. Specifically, when the toner-save printing mode is set ON (step S2: YES), the exposure power for the toner-save printing mode is set (step S7), and when the toner-save printing mode is set OFF (step S2: NO), the exposure power for the normal printing mode is set (step S8).

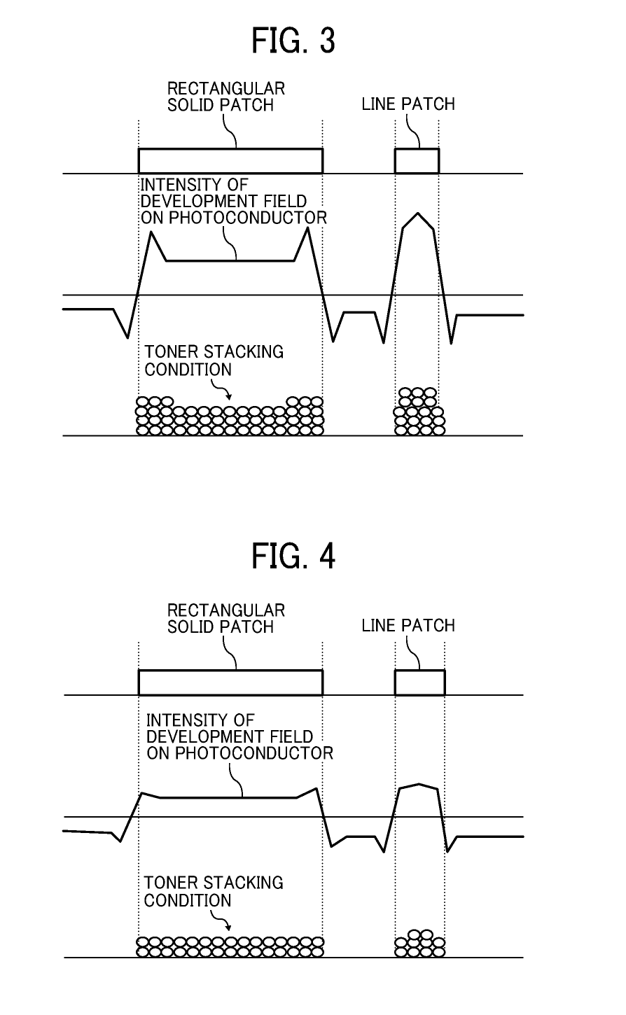

The exposure power set for the toner-save printing mode is lower than the exposure power of the normal printing mode. Further, the exposure power for the toner-save printing mode can be set in view of the amount of toner consumed that a user wants to reduce. For example, based on parameters set for the level of toner-saving consumption amount, the reduction amount of toner can be selectively set from a plurality of levels. The effect of decreasing the exposure power will be described later with reference to FIGS. 3 and 4.

At step S9, the image forming unit 206 forms the image using the exposure power set at step S7 (toner-save execution is ON) or the exposure power set at step S8 (toner-save execution is OFF), and then the image is output at step S10.

### (Effect of Decreasing Exposure Power)

A description is given of the effect of decreasing the exposure power. For the sake of comparison, a description is given of a case in which the exposure power is set at a higher value. FIG. 3 schematically shows development field intensity and toner adhering amount on a photoconductor when exposure power is set at a higher value, in which the exposure power means the exposure power set for the normal printing mode, which does not reduce amount of toner consumed.

The horizontal axis of FIG. 3 indicates positions on the photoconductor in the development direction, and an image is sequentially developed from left to right in FIG. 3. The upper-end view of FIG. 3 shows an image forming area on the photoconductor, in which a solid image patch (or rectangular solid image patch) such as one-inch square image patch is formed on a left side of imaging area, and an line image such as line patch having a width of 0.3 mm is formed on a right side of imaging area. Latent images for such images can be formed on the photoconductor by irradiating laser beams on the imaging area of the photoconductor.

The middle-level view of FIG. 3 shows intensity of development field on the imaging area of the photoconductor. The development field intensity on the photoconductor indicates the development field profile formed around the photoconductor and the development roll. Negatively-charged toner moves and adheres to the latent image formed on the imaging area of the photoconductor from the development roll with an effect of the development field generated by the development unit.

In the one-inch square solid image patch (i.e., image at the left side of FIG. 3), the development field intensity at each edge portion of the image increases due to high density of lines of electric force. Such phenomenon of high development field intensity of the image edge portion is called the edge effect. In the 0.3 mm line patch (i.e., image at the right side of FIG. 3), the development field intensity of the image edge portion becomes further high because the edge effect of both edge portions are superimposed.

The lower-end view of FIG. 3 shows toner accumulation condition or toner adhering amount on the photoconductor. The toner adhering amount at the edge portion of image becomes greater because the development field intensity at the edge portion of image is high. The portion that the toner adheres to in greater amount in the rectangular solid image patch of one-inch square becomes different depending on conditions. In this example case, the portion that the toner adheres with greater amount is, for example, 0.3 mm area from the edge of image, which is called as the edge portion.

The amount of toner adhering on the edge portion of image is, for example, 1.2 to 1.5 times of the amount of toner adhering in the inner portion of image. As for the 0.3 mm-width line patch (i.e., image at the right side of FIG. 3), the edge effects at the left and right sides of image are superimposed with each other, in which the edge effect of about 0.3 mm is observed from both sides, by which the toner adhering amount further increases.

When designing printers to reduce amount of toner consumed, the edge effect that causes excessive adhering of toner cannot be ignored. Accordingly, in the image processing apparatus 20, the exposure power of the toner-save printing mode is set lower to reduce the amount of toner to be adhered by the edge effect. A description is given of development field intensity and toner adhering amount on a photoconductor when exposure power is set at a lower value with reference to FIG. 4.

FIG. 4 schematically shows development field intensity and toner adhering amount on a photoconductor when exposure power is set at a lower value, in which the exposure power means the exposure power for the toner-save printing mode, which is lower than the exposure power for the normal printing mode.

Similar to the upper-end view, the middle-level view, the lower-end view of FIG. 3, the upper-end view of FIG. 4 shows the imaging area on the photoconductor, the middle-level view of FIG. 4 shows the development field intensity on the imaging area of the photoconductor, and the lower-end view of FIG. 4 shows the toner adhering amount on the photoconductor.

By lowering the exposure power for the solid image patch of one-inch square (i.e., image at left side of FIG. 4), the non-edge portion is charged with a lower exposing potential than an exposing potential of FIG. 3, by which the development field intensity decreases as shown in the middle-level view of FIG. 4. With such a configuration, the toner density can be decreased, and the thickness of toner on the entire image can be set thinner compared to using the high exposure power, by which the amount of toner consumed can be reduced.

For example, if the solid image patch of one-inch square is printed using the exposure power for the normal printing mode, the solid image density of each single color of cyan, magenta, yellow, black (C, M, Y, K) is set, for example, about 1.4. By controlling the exposure power at a lower value, the solid image density can be set, for example, about 1.0, by which the amount of toner consumed can be reduced, and thereby toner saving can be conducted effectively. With such configuration, the image density of solid image area can be reduced without drawing images by dot pattern, and thereby disappearance of thin lines and jaggedness of letters can be prevented.

Further, decreasing the exposure power is effective to suppress the edge effect. As shown in the middle-level view of FIG. 4, the development field intensity at the edge portion of the solid image patch of one-inch square of FIG. 4 is not so high compared to the development field intensity at the edge portion of the solid image patch of one-inch square of FIG. 3.

As such, by decreasing the exposure power, the edge effect can be reduced. As shown in the lower-end view of FIG. 4, excessive toner adhering at the edge portion of the solid image patch of one-inch square can be prevented, and excessive toner adhering on the line patch image can be prevented.

As such, by decreasing the exposure power for the toner-save printing mode compared to the exposure power for the normal printing mode, the toner density of the solid image area can be reduced, and excessive toner consumption caused by the edge effect can be suppressed, by which the amount of toner consumed can be reduced effectively.

### (Process to Prevent Lower Reproducibility of Discrete Dots)

As above described, by decreasing the exposure power for the toner-save printing mode compared to the exposure power for the normal printing mode, the amount of toner consumed can be reduced. However, if the exposure power is decreased, the reproducibility of discrete dots may deteriorate.

For example, if an electrophotographic machine adjusts the dot size to a plurality of different levels such as large dot, middle dot, small dot by modulating a pulse width of the emitted laser beam, a discrete dot (or small dot) that can be reproduced under a condition of the exposure power of the normal printing mode may not be reproduced effectively under a condition of the lower exposure power.

Before describing a generation process of dithering according to an example embodiment, a description is given of a decrease of reproducibility of discrete dot, which may occur due to the lower exposure power during the conventional generation process of dithering.

FIG. 5 shows a conventional generation process of clustered dithering that processes small-dot in advance, and FIG. 6 shows a conventional generation process of diffusion dithering that processes small-dot in advance. The reproducibility of discrete small-size dot can be maintained when the exposure power set for the normal printing mode is used. However, if the exposure power is set lower, the reproducibility of discrete small-size dot and the discrete middle-size dot may not be maintained or secured.

If the reproducibility of discrete small-size dot is not maintained or secured, in the clustered dithering of FIG. 5, the dithering pattern using the discrete small-size dot for highlight area in FIG. 5(1) may not be reproduced, by which the reproducibility of highlight area may be degraded.

Further, if the reproducibility of discrete small-size dot is not maintained or secured, in the diffusion dithering of FIG. 6, the effect of density growth may not occur to dithering patterns of FIGS. 6(1), 6(4), 6(7), and 6(10) having the discrete small-size dot, by which smoothness of dithering may be degraded, and thereby smoothness of gradient may be degraded.

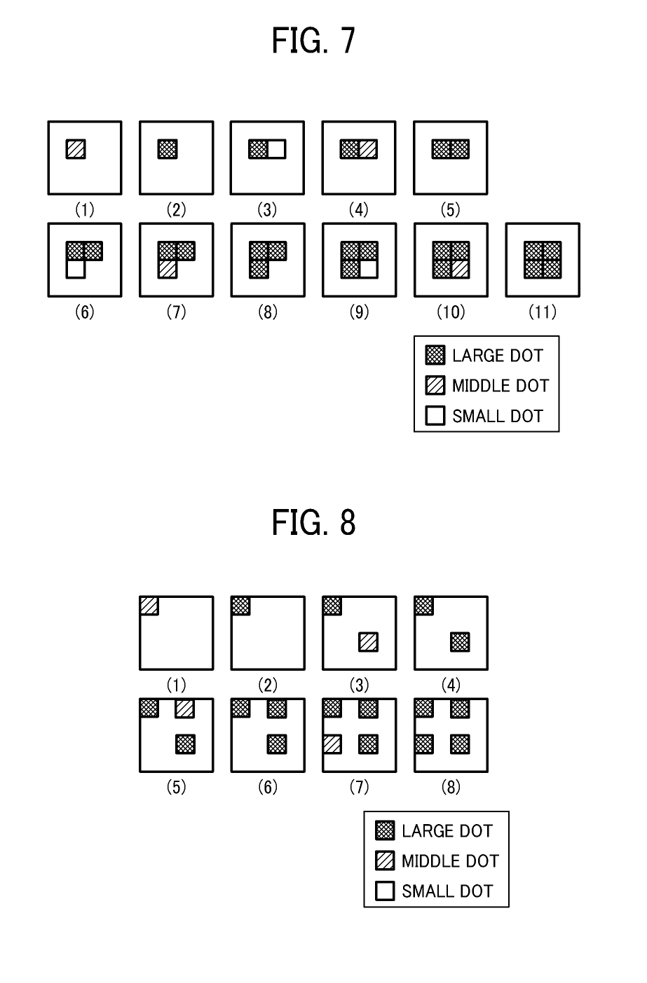

In view of such problems, in the image processing apparatus 20, a decrease of reproducibility of discrete dots can be prevented by conducting a generation process of dithering according to an example embodiment. In particular, a dithering using a generation process according to an example embodiment is devised as shown in FIGS. 7 and 8. FIG. 7 schematically shows a generation process of clustered dithering excluding a dithering pattern for discrete small-size dot when exposure power is changed to a lower value, and FIG. 8 schematically shows a generation process of diffusion dithering excluding a dithering pattern for discrete small-size dot when exposure power is changed to a lower value.

The patterns of FIGS. 7(1) to 7(11) and the patterns of FIGS. 5(2) to 5(12) show the same patterns respectively. As such, the generation process of the dithering shown in FIG. 7 can be set by excluding the dithering pattern of discrete dot of FIG. 5(1), which may not be secured or maintained for the reproducibility of discrete small-size dots, from the generation process of dithering of FIG. 5.

Further, the patterns of FIGS. 8(1),8(2), 8(3), 8(4), 8(5), 8(6), 8(7), and 8(8) and the patterns of FIGS. 6(2), 6(3), 6(5), 6(6), 6(8), 6(9), 6(11), and 6(12) show the same patterns respectively. As such, the generation process of dithering shown in FIG. 8 can be set by excluding the dithering patterns of discrete dots of FIGS. 6(1), 6(4), 6(7), and 6(10), which degrades the smoothness of gradient of the dithering, from generation process of the dithering of FIG. 6.

As for the image processing apparatus 20, when the normal printing mode is shifted or switched to the toner-save printing mode, the generation process shown in FIGS. 5 and 6 can be shifted or switched to the generation process shown in FIGS. 7 and 8, by which the reproducibility of highlight area, the smoothness of gradient of the dithering can be secured or maintained even if the exposure power is changed to a lower value.

By using the dithering patterns shown FIG. 7 excluding the dithering pattern using the discrete small-size dot for highlight area, the reproducibility of highlight area can be secured or maintained without degradation. Further, by using the dithering patterns shown FIG. 8 excluding the dithering pattern using the discrete small-size dot for the highlight area and also for the dithering pattern of middle density, the dithering density generation can be smoothly conducted.

By excluding specific dithering patterns as above described, the numbers of gradient of the dithering may be reduced. However, actually-used dithering patterns can be set by combining the dithering patterns shown in FIGS. 7 and 8 in the two-dimensional direction, as required. Therefore, the numbers of gradient can be secured at 255 or more even if specific dithering patterns are not used. Therefore, upon securing the numbers of gradient of 255 or more, the threshold value of the dithering and the gamma table can be adjusted to generate desired density property for the toner-save printing mode, by which images having high numbers of gradient and smooth density property can be obtained.

In the above described example, it is assumed that the discrete small-size dot is not reproduced by the multi-level dithering of two bit information composed of small dot, middle dot, and large dot. Further, if the discrete middle-size dot is not also reproduced in addition to the discrete small-size dot, or when the continuously existing discrete small-size dot is not reproduced, the dithering pattern not having an effect on the density generation can be excluded from the generation process of dithering.

Further, the multi-level dithering is not limited to the multi-level dithering of two-bit information, but other multi-level dithering such as the multi-level dithering of four-bit information can be used, in which the dithering pattern not having an effect on the density generation can be excluded from the generation process of dithering when the exposure power is changed to a lower value.

In the above described image processing apparatus, by decreasing the exposure power for the toner-save printing mode compared to the exposure power for the normal printing mode, the density of a solid image area can be reduced, and excessive toner consumption caused by the edge effect can be suppressed or prevented, by which the amount of toner consumed can be reduced effectively.

Further, by excluding the dithering pattern not having an effect on the density generation from the generation process of dithering, disappearance of dots at highlight area, stagnation of density during the generation process of dithering can be prevented, by which the reproducibility of highlight area, and the smoothness of gradient of the dithering can be maintained or secured.

In the above described image processing apparatus, when the toner-save printing mode is set, disappearance of solid thin lines due to the interference with dithering pattern and jaggedness at edge portions of letters can be suppressed, and excessive toner consumption caused by the edge effect can be suppressed.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a Wireless Application Protocol (WAP) or 3G-compliant phone) and so on. Since the present invention can be implemented as software, each and every aspect of the present invention thus encompasses computer software implementable on a programmable device.

The computer software can be provided to the programmable device using any storage medium or carrier medium for storing processor readable code such as a flexible disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, but not limited these.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above described embodiments, at least one or more of the units of apparatus can be implemented in hardware or as a combination of hardware/software combination. In example embodiment, processing units, computing units, or controllers can be configured with using various types of processors, circuits, or the like such as a programmed processor, a circuit, an application specific integrated circuit (ASIC), used singly or in combination.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An image processing apparatus comprising:
an exposure unit to expose a photoconductor to form an electrostatic latent image on the photoconductor;
a development unit to develop the electrostatic latent image on the photoconductor as a toner image using toner; and
an exposure power controller to control exposure power of the exposure unit depending on a printing mode including a normal printing mode and a toner-save printing mode in which less toner is consumed than in the normal printing mode,
the exposure power controller decreasing the exposure power of the exposure unit for the toner-save printing mode compared to the exposure power of the exposure unit for the normal printing mode.

2. The image processing apparatus of claim 1, wherein the toner-save printing mode supports a selectable level of toner-saving consumption amount, and the exposure power controller variably sets the exposure power of the exposure unit depending on a selected level of the toner-saving consumption amount.

3. The image processing apparatus of claim 1, further comprising a halftone processing device to process image data by dithering,
wherein the halftone processing device can select different dithering generation processes for the normal printing mode and the toner-save printing mode,
wherein the dithering generation process for the toner-save printing mode excludes a dithering pattern that does not contribute density from the dithering generation process for the normal printing mode generation due to decreased exposure power.

4. An image processing method comprising the steps of:
1) exposing a photoconductor to form an electrostatic latent image on the photoconductor;
2) developing the electrostatic latent image on the photoconductor as a toner image using toner;
3) determining whether a toner-save printing mode is set; and
4) decreasing exposure power for the toner-save printing mode from the exposure power for the normal printing mode at the exposing step when the determining step determines that the toner-save printing mode is set.

5. A non-transitory computer-readable storage medium storing a program that, when executed by a computer, causes the computer to execute a method of image processing comprising the steps of:
1) exposing a photoconductor to form an electrostatic latent image on the photoconductor;
2) developing the electrostatic latent image on the photoconductor as a toner image by using toner;
3) determining whether a toner-save printing mode is set; and
4) decreasing the exposure power for the toner-save printing mode from the exposure power for the normal printing mode at the exposing step when the determining step determines that the toner-save printing mode is set.
